(19) United States
(12) Patent Application Publication
(10) Pub. No.: US 2005/0237732 A1
(43) Pub. Date: Oct. 27, 2005

(54) Shelf lighting mounting system

(76) Inventors: Curtis N. Lagman, Jacksonville, FL (US); Robert J. Pape, Ponte Vedra Beach, FL (US); David M. Lasch, Jacksonville, FL (US)

Correspondence Address: BAKER, DONELSON, BEARMAN,;CALDWELL & BERKOWITZ, P.C., 5 CONCOURSE PARKWAY, STE. #900, ATLANTA, GA, 30328, US

(21) Appl. No.: 11/097,485

(22) Filed: Apr. 1, 2005

Related U.S. Application Data
(60) Provisional application No. 60/564,015, filed on Apr. 21, 2004.

(51) Int. Cl. F21V 33/00

(52) U.S. Cl. 362/132; 362/127

(57) ABSTRACT

A shelf lighting system (10) is disclosed which includes a pair of vertical mounting rails (11) and a plurality of horizontal shelves (12) coupled to the mounting rails through mounting brackets (13). Each vertical mounting rail has a outwardly facing side wall (16), a front wall (17), and inwardly facing side step wall (18), a rear step wall (19), and an inwardly facing side bracket wall (20). As such, the inwardly facing side bracket wall is recessed behind the front wall so that it is hidden from view. Each shelf has a pair of slots (32) extending into the shelf and one or more light sources (36) positioned within the shelf to provide light. The light source(s) has a pair of electrical conductors (37) which extend through holes (38) passing through the shelf and which terminate with contacts (39). Each metal mounting bracket has an elongated horizontal tongue (41) which extends to a mounting portion (42). The tongue is sized and shaped to be received within the slot of the shelf. Electricity passes through the rails, through the brackets, and through the conductors so as to energize the light source(s).

### REFERENCE TO RELATED APPLICATION

This is a continuation-in-part of U.S. patent application Ser. No. 60/564,015 filed Apr. 21, 2004.

### TECHNICAL FIELD

This invention relates generally to lighting systems, and specifically to lighting systems that are associated with shelving.

### BACKGROUND OF THE INVENTION

Shelving is often highlighted with accent lights to illuminate or highlight items placed on the shelving. Such accent lights are readily available on today's china cabinets, bookcases, hutches, and the like which include a downwardly projecting light mounted to the top of the cabinet. A problem with such lighting is that fact that the light can only illuminate one level of shelving if the shelving is made of an opaque substance such as wood. Thus, items displayed on shelves below the illuminated shelf are not illuminated. Alternatively, a shelf may be made of a transparent material such as glass. Here however, each shelf below the light source receives less and less light due to the light being reflected and refracted by each glass shelf. Furthermore, items placed upon the shelf may cast shadows upon underlying shelves. As with the opaque shelves, the light associated with glass shelves is fixed in height and therefore cannot be adjusted in height relative to the underlying shelving.

Accordingly, it is seen that a need remains for a lighting system that can be adapted to illuminate multiple shelves and which may be adjusted in height. It is to the provision of such therefore that the present invention is primarily directed.

### SUMMARY OF THE INVENTION

In a preferred form of the invention a shelf lighting system adapted to be mounted to a support wall comprises a pair of upright, electrically conductive mounting rails coupled to an electric power source, each mounting rail having a front wall and at least one side wall, the side wall having a plurality of holes therethrough. The system also includes a pair of electrically conductive mounting brackets, each mounting bracket having an elongated portion and a mounting portion, the mounting portion having a catch extending generally normal to the elongated portion configured to mate with the mounting rail slot, and at least one shelf having a pair of slots therein, each slot being configured to receive one mounting bracket elongated portion. The shelf also having a first electrical contact positioned to electrically contact one mounting bracket and a second electric contact positioned to electrically contact the other mounting bracket. The shelf also has an electric light source having one electrical conductor coupled to the first electrical contact and a second electrical conductor coupled to the second electrical contact. With this construction, the brackets are coupled to the mounting rails by coupling the catches to the holes, and electricity is passed through the light source by passing it through the rails, through the mounting brackets, and through the electrical conductors in electrical contact with the brackets.

### BRIEF DESCRIPTION OF THE DRAWING

FIG. 1. is a perspective view of a shelf light mounting system in a preferred embodiment.

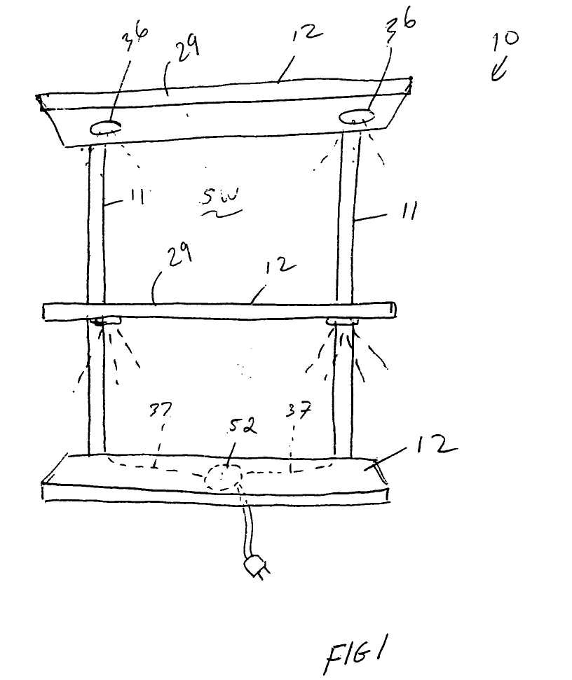

FIG. 2 is a perspective view of the shelf light mounting system of FIG. 1, showing a portion of the system in more detail.

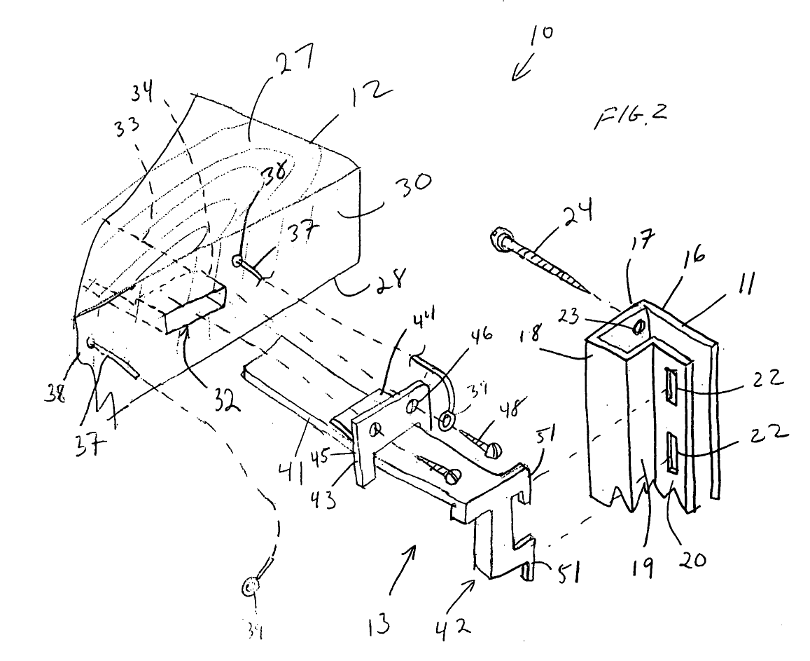

### DETAILED DESCRIPTION

With reference next to the drawings, there is shown in a shelf lighting mounting system 10 embodying principles of the invention in a preferred form. The system 10 includes a pair of vertical electrically conductive mounting rails 11 and a plurality of removable horizontal shelves 12 coupled to the mounting rails 11 through electrically conductive mounting brackets 13. The vertical mounting rails 11 may be mounted directly upon a building's wall or may be mounted upon the front surface of the back wall of a cabinet or the like in order to produce an article of furniture having shelving, such as a bookcase, china cabinet, hutch or the like. As used herein, the wall to which the mounting rails are mounted will be referred to as the support wall regardless of whether this wall is incorporated into furniture or not.

Each vertical mounting rail 11 has a generally hollow L-shaped configuration defined by an outwardly facing side wall 16, a front wall 17, and inwardly facing side step wall 18, a rear step wall 19, and an inwardly facing side bracket wall 20. As such, the inwardly facing side bracket wall 20 is recessed behind the front wall 17 so that it is hidden from view. The front wall 17 has a series of mounting holes 23 through which mounting screws 24 may pass and be threaded into the support wall to secure the position of the vertical rails 11. It should be understood that the pair of vertical mounting rails 11 are preferrably mirror images of each other so that the side bracket walls 20 of each face each other when affixed to the support wall.

Each horizontal shelf 12 has a top surface 27, a bottom surface 28, a front surface 29 and a rear surface 30. The shelf 12 also has a pair of grooves or slots 32 extending into the shelf from the rear surface 30. Each slot 32 has an elongated portion 33 and a notched or cut-out portion 34 extending to the elongated portion 33. The shelf 12 also includes one or more light sources 36, preferably 12 volt d.c. light(s), positioned within the shelf to provide light. The light source(s) 36 has a pair of electrical conductors 37 which extend through holes 38 passing through the shelf 12 to the light source(s) 36. Each electrical conductor 37 terminates with an annular contact 39.

Each metal mounting bracket 13 has an elongated horizontal tongue 41 which extends to a mounting portion 42. The tongue 41 is sized and shaped to be received within the slot 32 of the shelf. The tongue 41 also includes a metallic insert slide 43 having a horizontal lip 44 that is configured to be received within the notched portion 34 to provide an electrical contact surface with the tongue 41, and a vertical wall 45 with a screw mounting hole 46 therein. A metal mounting screw 48 passes through and in electrical contact with each conductor contact 39 and is threaded into the shelf 12 so as to sandwich the contact 39 between the head of the screw 48 and the insert slide vertical wall 45. Obviously, one contact 39 is coupled to one bracket while the other contact is coupled to the other bracket. The bracket mounting portion 42 has a pair of L-shaped hooks or catches 51 which extend generally normal to the tongue 41 which are configured to be passed into the mounting slots 22 of the vertical mounting rails 11 and be moved downwardly so as to lock the bracket 13 onto the vertical mounting rail 11. As shown in the drawings, once the mounting bracket 13 is coupled to the vertical mounting rail a portion of the mounting bracket abuts the rear step wall 19 of the mounting rails.

The use of a 12 volt d.c. light source requires the use of a transformer 52 that converts 110 volt ac household current to 12 volt d.c. current. The transformer 52 is coupled to the vertical mounting rails 11 so that the d.c. current is passed to the vertical mounting rails. This d.c. current passes through the vertical mounting rails, through the mounting brackets 13 in electrical contact with the vertical mounting rails 11, through the conductors 37 in electrical contact with the mounting brackets and through the light source(s) 36. Thus, the light sources 36 are energized with electricity passing through these components which permit a complete electrical circuit. The shelves 13 may be moved to any position along the vertical mounting rails and maintained in electrical contact therebetween.

It should be understood that the present mounting rails 11 and mounting brackets 13 provide distinct benefits over those of the prior art. Here, the mounting slots 22 are positioned upon the inwardly facing side bracket wall to obstruct them from view, as these slots are aesthetically unpleasing. Furthermore, the front wall 17, inwardly facing side step wall 18 and rear step wall 19 form a step which further obstruct the view of the mounting slots 22.

It should also be understood that by having the mounting portion 42 of the mounting brackets mounted in this manner the weight of the shelf and anything thereon is not directed solely on the metal wall having the mounting slots, a problem long associated with the prior art wherein the catches may pull through or deform the wall defining the slots should the shelf become overloaded with weight. Here, the force of the weight causes the bracket to push against or abut the rear step wall 19 of the rails, thereby placing a portion of the force upon the rear wall and limiting the force extending through the catches upon the inwardly facing side bracket wall. It should be understood that the front wall 17 and rear wall 19 may be manufactured as one single, unitary wall rather than two separate walls as shown in the drawings, i.e., one wall with a front surface and a rear surface.

It should also be understood that the bracket of the present invention is obstructed from view, another problem associated with brackets of the prior art. Here, the top of the mounting portion 42 is obstructed by the shelf while the lower port of the mounting portion 42 is obstructed by the step of the vertical mounting rails. This configuration of the bracket provides an aesthetic advantage over brackets of the prior art.

It should be understood that all surfaces of the vertical mounting rails 11, except for the inwardly facing side bracket wall 20, may be painted to provide an aesthetically pleasing appearance. The inwardly facing side bracket wall 20 is left unpainted to provide a good electrical contact surface with the mounting bracket 13. However, it should be understood that rails and/or bracket may be made partially electrically conductive, such as a conductive strip extending along a portion of the rail and/or bracket. As such, the term electrically conductive is not intended to mean that the entire structure is electrically conductive.

Lastly, it should be understood that as an alternative to the mounting screws 24 shown in the preferred embodiment, the mounting rails may be mounted to the support wall through other commonly used devices, such as bolts, nails, adhesives, mounting brackets, or other ancillary structure such as the top or bottom walls of the cabinet.

It thus is seen that a shelf lighting system is provided which enables multiple shelves to be illuminated and be removed or relocated efficiently. Furthermore, the components of these shelves are strong and aesthetically unobtrusive. Although it has been shown and described in its preferred form, it should be understood that other modifications, additions or deletions may be made thereto without departure from the spirit and scope of the invention as set forth in the following claims.

1. A shelf lighting system adapted to be mounted to a support wall comprising:
a pair of upright, electrically conductive mounting rails coupled to an electric power source, each mounting rail having a front wall and at least one side wall, said side wall having a plurality of holes therethrough,
a pair of electrically conductive mounting brackets, each mounting bracket having an elongated portion and a mounting portion, said mounting portion having a catch extending generally normal to said elongated portion configured to mate with said mounting rail slot; and
at least one shelf having a pair of slots therein, each slot being configured to receive one said mounting bracket elongated portion, said shelf also having a first electrical contact positioned to electrically contact one said mounting bracket and a second electric contact positioned to electrically contact the other said mounting bracket, said shelf also having an electric light source having one electrical conductor coupled to said first electrical contact and a second electrical conductor coupled to said second electrical contact,
whereby the brackets are coupled to the mounting rails by coupling the catches to the holes, and whereby electricity is passed through the light source by passing it through the rails, through the mounting brackets, and through the electrical conductors in electrical contact with the brackets.

2. The shelf lighting system of claim 1 wherein each said mounting bracket has two catches.

3. The shelf lighting system of claim 1 wherein each said upright mounting rail side wall is recessed behind said mounting rail front wall.

4. The shelf lighting system of claim 3 wherein each said upright mounting rail also includes a rear wall adjacent said side wall, and wherein said mounting bracket mounting portions are configured to abut said rear walls.

5. The shelf lighting system of claim 1 wherein each said mounting bracket includes a slide configured to abut said elongated portion.

6. The shelf lighting system of claim 5 wherein each said slide is coupled to one said electrical contact.

7. The shelf lighting system of claim 5 wherein each said shelf slot is configured to receive a portion of one said slide.

8. A shelf lighting system adapted to be mounted to a support wall comprising:
two electrically conductive rails, each said rail having a front wall aligned generally parallel to the support wall and a side wall aligned generally normal to the support wall;
mounting means for mounting said rails to the support wall;
two electrically conductive shelf mounting brackets, each said mounting bracket being adapted to be mounted to said side wall of one said rail; and
at least one shelf, said shelf also having a first electrical contact positioned to electrically contact one said mounting bracket and a second electric contact positioned to electrically contact the other said mounting bracket, said shelf also having an electric light source having one electrical conductor coupled to said first electrical contact and a second electrical conductor coupled to said second electrical contact,
whereby the brackets are coupled to the mounting rails, and whereby electricity is passed through the light source by passing it through the rails, through the mounting brackets, and through the electrical conductors in electrical contact with the brackets.

9. The shelf lighting system of claim 8 wherein said shelf has two slots therein, each slot being configured to received an elongated portion of one said mounting bracket.

10. The shelf lighting system of claim 8 wherein each said mounting bracket has two catches.

11. The shelf lighting system of claim 8 wherein each said rail side wall is recessed behind said rail front wall.

12. The shelf lighting system of claim 11 wherein each said rail also includes a rear wall adjacent said side wall, and wherein said mounting brackets are configured to abut said rear walls.

13. The shelf lighting system of claim 9 wherein each said mounting bracket includes a slide configured to abut said mounting bracket elongated portion.

14. The shelf lighting system of claim 13 wherein each said slide is coupled to one said electrical contact.

15. The shelf lighting system of claim 13 wherein each said shelf slot is configured to receive a portion of one said slide.

16. A shelf system adapted to be mounted to a support wall comprising:
two rails each having a front wall aligned generally parallel to the support wall, a rear wall aligned generally parallel to the support wall, and a side wall aligned generally normal to the support wall, each said rail side wall being recessed behind said rail front wall;
mounting means for mounting said rails to the support wall;
two shelf mounting brackets each being adapted to be mounted to said side wall of one said rail, said mounting brackets being configured to abut said rear walls; and
at least one shelf adapted to be coupled to said mounting brackets,
whereby the brackets are coupled to the mounting rails.

17. The shelf system of claim 16 wherein each said mounting bracket has two catches.

18. The shelf system of claim 16 wherein said rails and said mounting brackets are electrically conductive, and wherein said shelf also having a first electrical contact positioned to electrically contact one said mounting bracket and a second electric contact positioned to electrically contact the other said mounting bracket, said shelf also having an electric light source having one electrical conductor coupled to said first electrical contact and a second electrical conductor coupled to said second electrical contact,
whereby electricity is passed through the light source by passing it through the rails, through the mounting brackets, and through the electrical conductors in electrical contact with the brackets.

19. The shelf lighting system of claim 18 wherein each said mounting bracket includes a slide configured to abut said mounting bracket elongated portion.

20. The shelf lighting system of claim 19 wherein each said slide is coupled to one said electrical contact.

21. The shelf lighting system of claim 19 wherein each said shelf slot is configured to receive a portion of one said slide.
